(19) United States
(12) Patent Application Publication
(10) Pub. No.: US 2003/0042733 A1
(43) Pub. Date: Mar. 6, 2003

(54) Time zone converter for a luggage tag or ticket wallet

(76) Inventors: Martin Zoland, Melbourne (AU); Sang K. Kim, Sante Fe Springs, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/941,445

(22) Filed: Aug. 28, 2001

(51) Int. Cl. B42D 15/00

(52) U.S. Cl. 283/74

(57) ABSTRACT

A luggage tag which has a main body portion, an attachment mechanism for coupling the main body portion to a piece of luggage, and a time zone converter coupled to the main body portion. The time zone converter has a base, a first set of markings disposed on the base, an indicator slidably coupled to the base, and a second set of markings disposed on the indicator. In various embodiments, the first set of markings can represent geographic locations such as cites, and the second set of markings can represent time divisions in hours and/or minutes or vice versa. In addition, the time divisions can be based on either a 12-hour or a 24-hour scale.

### FIELD OF THE INVENTION

The present invention relates to luggage tags and ticket wallets, more particularly luggage tags and ticket wallets which include time zone converters.

### BACKGROUND

Since the advance of transportation technology, the world has become a smaller place. Indeed, travel between continents is an everyday occurrence for many business people. Regardless of whether it is by plane, ship, or train, distances traversed today are much greater than in years past due to the high speeds at which these vessels travel. Thus, the vast distances traveled make it inevitable that during the course of a trip a traveler may have to change time zones. For instance, international business travelers change time zones on a regular basis. Even traveling across the United States from Los Angeles to New York requires crossing three times zones; namely, from Pacific to Mountain to Central to Eastern time zones. For active travelers who must constantly change time zones, it can be a nuisance to mentally estimate the correct time zone at the destination. For business travelers who have to schedule meetings, proper calculation of local time is crucial to coordinate personnel who are in remote locales.

There have been efforts to simplify the active traveler's task. One such device electronically performs the time zone conversion. The circuitry is adapted to a two-dimensional map of the world that is touch sensitive. By pressing down on different parts of the map to indicate the specific geographic location, the user triggers a microprocessor that calculates the local time at the touched location. Unfortunately, such a device is expensive. Also, the device requires batteries to operate. Finally, just remembering to bring the device along on trips limits its usefulness.

Some specialized digital wristwatches have an electronic time zone conversion feature. Other wristwatches rely on a rotating bezel to perform the time zone conversion. However, buying a wristwatch specifically for its time conversion feature may not always be appropriate.

Other attempts to provide travelers with time zone conversion devices are disclosed in U.S. Pat. Nos. 5,303,956 and 5,228,722. Both of the referenced patents utilize two discs which are rotatably coupled in a concentric manner. However, this configuration is not optimal for placement on a luggage tag or in a ticket wallet.

Therefore, a need presently exists for providing a convenient means of incorporating a time zone conversion device with a luggage tag or a ticket wallet.

### SUMMARY

In an embodiment, a luggage tag is disclosed which has a main body portion, an attachment mechanism for coupling the main body portion to a piece of luggage, and a time zone converter coupled to the main body portion. The time zone converter has a base, a first set of markings disposed on the base, an indicator slidably coupled to the base, and a second set of markings disposed on the indicator. In various embodiments, the first set of markings can represent geographic locations such as cites, and the second set of markings can represent time divisions in hours and/or minutes or vice versa. In addition, the time divisions can be based on either a 12-hour or a 24-hour scale.

According to various embodiments, a user can obtain a time zone conversion by sliding the indicator in a linear direction relative to the base to align the first set of markings with the second set of markings to obtain a first pair of aligned first and second markings which indicates a first time in a first time zone and a second pair of aligned first and second markings which indicates a second time in a second time zone.

In another embodiment, the base is substantially cylindrical or elliptical with the indicator rotatably coupled to the base such that the indicator is disposed approximately about a circumference of the base. Thus, the indicator rotates about the base in order to align the first and second set of markings to obtain a time conversion.

In another embodiment, a ticket wallet is disclosed which has a first leaf, a second leaf, and a time zone converter coupled to at least one of the first leaf and the second leaf. The time zone converter has a base, a first set of markings disposed on the base, an indicator slidably coupled to the base, and a second set of markings disposed on the indicator. Similar to other embodiments, this configuration allows a user to slide the indicator in a linear direction relative to the base to align the first set of markings with the second set of markings to obtain a first pair of aligned first and second markings which indicates a first time in a first time zone and a second pair of aligned first and second markings which indicates a second time in a second time zone.

### BRIEF DESCRIPTION OF THE DRAWINGS

Various embodiments are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a view of a luggage tag according to an embodiment in which the indicator is of the sliding variety.

FIG. 2 is a view of a luggage tag according to another embodiment in which the indicator is of the sliding variety.

FIG. 3 is a view of a ticket wallet according to an embodiment.

FIG. 4 is a view of a luggage tag according to an embodiment in which the indicator is of a rotating variety.

### DETAILED DESCRIPTION

The embodiments disclosed herein overcome the problems in the existing art described above by providing a device which enables travelers to easily and conveniently convert a first time in a first time zone to second time in a second time zone. In the following description, for the purposes of explanation, numerous specific details are set forth in order to provide a thorough understanding of the various embodiments. It will be apparent, however, to one skilled in the art that the embodiments may be practiced without some of these specific details. The following description and accompanying drawings provide various examples for the purposes of illustration. However, these examples should not be construed in a limiting sense as they are merely intended to provide examples rather than to provide an exhaustive list of all possible implementations.

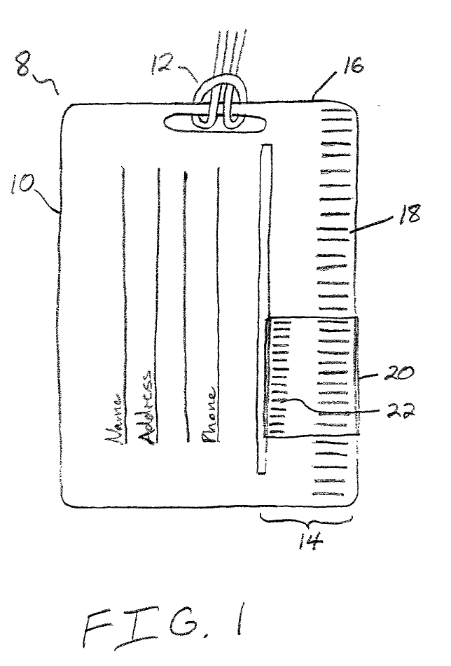

Referring to FIG. 1, a luggage tag 8 is shown according to an embodiment in which the luggage tag 8 has a main body portion 10 and an attachment 12 for coupling the main body portion 10 to a piece of luggage. Although the attachment mechanism 12 shown is a piece of elongate material fastened to the main body portion 10, it is contemplated to use any suitable attachment mechanism for fastening the main body portion 10 to a piece of luggage. The luggage tag 8 also has a time zone converter 14 coupled to the main body portion 10. The time zone converter 14 includes a base 16, a first set of markings 18 disposed on the base 16, an indicator 20, and a second set of markings 22 disposed on the indicator 20. The indicator 20 is coupled to the base 16 such that the indicator 20 can slide along the base in a linear fashion relative to the base 16. The first set of markings 18 and the second set of markings 22 can be names of geographic locations and time divisions, respectively. Alternatively, the first set of markings 18 could be time divisions while the second set of markings 22 could be names of geographic locations. Regardless of the configuration of the markings, a user can slide the indicator 20 along the base 16 to align the first set of markings with the second set of markings to obtain a first pair of aligned first and second markings which indicates a first time in a first time zone and a second pair of aligned first and second markings which indicates a second time in a second time zone.

In an embodiment, the time divisions are in increments of hours, and the names of geographic locations are names of cities. Additionally, the time divisions can include subdivisions in increments of minutes. In another embodiment, the time divisions can be based on either a 12-hour or a 24-hour scale.

It should be noted that although FIG. 1 includes a base 16 which is substantially flat, the base 16 may be any suitable size and shape so long as the indicator 20 can still slide in a linear direction relative to the base 16.

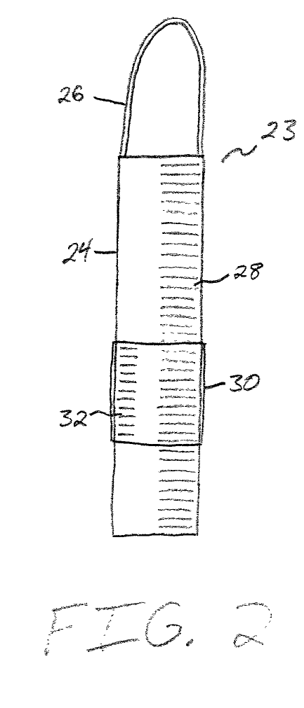

FIG. 2 shows an alternative to the embodiment depicted in FIG. 1. For example, a luggage tag 23 has a main body portion and a base of the time converter which are one integrated piece 24 with an attachment mechanism 26 for coupling the integrated piece 24 to a piece of luggage. A first set of markings 28 is disposed on the integrated piece 28, and an indicator 30 is coupled to the integrated piece 28 such that the indicator 30 can slide in a linear manner relative to the integrated piece 28. The indicator 30 has a second set of markings 32 disposed on the indicator 30 so that the markings can be aligned to obtain a time conversion as described with respect to FIG. 1. Thus, FIG. 2 shows an example of an embodiment in which the main body portion of the luggage tag and the base of the time converter are one in the same. It is worth noting that in this embodiment, the space for providing personal information on the luggage tag 23 is disposed on the other side of the luggage tag 23, which is not shown in FIG. 2.

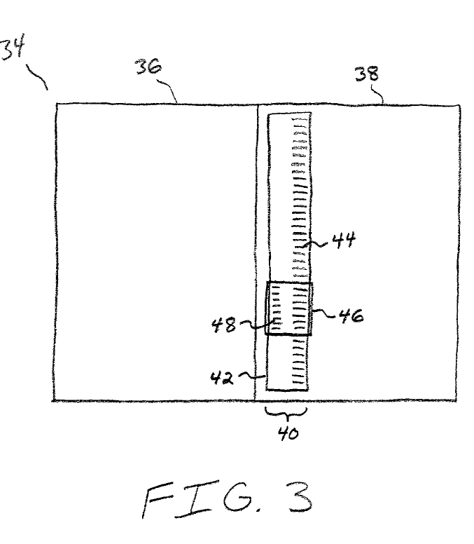

Turning now to FIG. 3, an embodiment of a ticket wallet 34 is shown in which the ticket wallet 34 has a first leaf 36, a second leaf 38, and a time zone converter 40 coupled to the second leaf 38. However, the time zone converter 40 can be coupled to either the first leaf 36 or the second leaf 38 or to both the first leaf 36 and the second leaf 38. Focusing now on the time converter 40, a first set of markings 44 is disposed on the base 42. An indicator 46 is coupled to the base 42 so that the indicator 46 can slide in a linear manner relative to the base 42. A second set of markings 48 is disposed on the indicator 46. Thus, a user can obtain a time conversion by aligning the first set of markings 44 with the second set of markings 48 as described above in reference to FIG. 1.

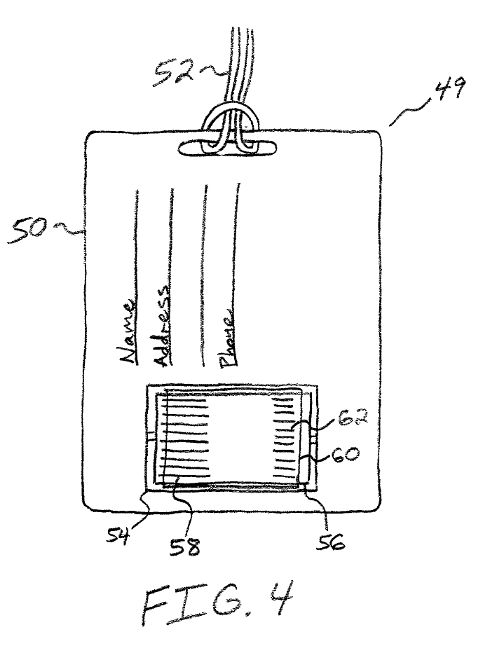

Referring to FIG. 4, an embodiment is shown in which a luggage tag 49 has a main body portion 50 and an attachment mechanism 52 for coupling the main body portion 50 to a piece of luggage. The luggage tag 49 also has a time converter 54 coupled to the main body portion 50. The time converter 54 has a base 56 which is substantially cylindrical or elliptical and a first set of markings 58 disposed on the base 56. In addition, the time converter 54 has an indicator 60 coupled to the base 56 such that the indicator 60 is disposed approximately around a circumference of the base 56 so that the indicator 60 can rotate about the base 56. The indicator 60 also has a second set of markings 62 disposed thereon so that the indicator 60 can be rotated to align the first set of markings 58 with the second set of markings 62 in order to obtain a time conversion.

Although FIG. 4 shows an embodiment wherein only the indicator 60 rotates, it is contemplated to have embodiments in which the indicator 60 remains stationary while the base 56 rotates relative to the indicator 60. Alternatively, both the indicator 60 and the base 56 could be rotatable relative to each other. Although not depicted in the figures, it is contemplated to implement an indicator of the rotating variety in the ticket wallet embodiment described above.

It is to be understood that even though numerous characteristics and advantages of various embodiments have been set forth in the foregoing description, together with details of the structure and function, this disclosure is illustrative only. Changes may be made in detail, especially matters of structure and management of parts, without departing from the scope of the embodiments as expressed by the broad general meaning of the terms of the appended claims.

We claim:

1. A luggage tag comprising:
a main body portion;
an attachment mechanism for coupling the main body portion to a piece of luggage; and
a time zone converter coupled to the main body portion, the time zone converter comprising:
a base;
a first set of markings disposed on the base;
an indicator slidably coupled to the base; and
a second set of markings disposed on the indicator such that the indicator is movable in a linear direction relative to the base to align the first set of markings with the second set of markings to obtain a first pair of aligned first and second markings which indicates a first time in a first time zone and a second pair of aligned first and second markings which indicates a second time in a second time zone.

2. The luggage tag of claim 1, wherein the first set of markings are time divisions and the second set of markings are names of geographic locations.

3. The luggage tag of claim 1, wherein the first set of markings are names of geographic locations and the second set of markings are time divisions.

4. The luggage tag of claim 3, wherein the names of geographic locations are names of cities and the time divisions are in increments of hours.

5. The luggage tag of claim 4, wherein the time divisions have subdivisions in increments of minutes.

6. The luggage tag of claim 4, wherein the time divisions are based on a 12-hour scale.

7. The luggage tag of claim 4, wherein the time divisions are based on a 24-hour scale.

8. A luggage tag comprising:
a main body portion;
an attachment mechanism for coupling the main body portion to a piece of luggage; and
a time zone converter coupled to the main body portion, the time zone converter comprising:
a base which is substantially cylindrical;
a first set of markings disposed on the base;
an indicator rotatably coupled to the base such that the indicator is disposed approximately about a circumference of the base; and
a second set of markings disposed on the indicator such that the indicator is movable in relation to the base to align the first set of markings with the second set of markings to obtain a first pair of aligned first and second markings which indicates a first time in a first time zone and a second pair of aligned first and second markings which indicates a second time in a second time zone.

9. The luggage tag of claim 8, wherein the base is substantially elliptical.

10. The luggage tag of claim 8, wherein the first set of markings are names of geographic locations and the second set of markings are time divisions.

11. The luggage tag of claim 10, wherein the names of geographic locations are names of cities and the time divisions are in increments of hours.

12. The luggage tag of claim 11, wherein the time divisions are based on a 12-hour scale.

13. The luggage tag of claim 11, wherein the time divisions are based on a 24-hour scale.

14. A ticket wallet comprising:
a first leaf and a second leaf; and
a time zone converter coupled to at least one of the first leaf and the second leaf, the time zone converter comprising:
a base;
a first set of markings disposed on the base;
an indicator slidably coupled to the base; and a second set of markings disposed on the indicator such that the indicator is movable in a linear direction relative to the base to align the first set of markings with the second set of markings to obtain a first pair of aligned first and second markings which indicates a first time in a first time zone and a second pair of aligned first and second markings which indicates a second time in a second time zone.

15. The ticket wallet of claim 14, wherein the first set of markings are time divisions and the second set of markings are names of geographic locations.

16. The ticket wallet of claim 14, wherein the first set of markings are names of geographic locations and the second set of markings are time divisions.

17. The ticket wallet of claim 16, wherein the names of geographic locations are names of cities and the time divisions are in increments of hours.

18. The ticket wallet of claim 17, wherein the time divisions have subdivisions in increments of minutes.

19. The ticket wallet of claim 17, wherein the time divisions are based on a 12-hour scale.

20. The ticket wallet of claim 17, wherein the time divisions are based on a 24-hour scale.
